(19) United States
(12) Patent Application Publication
(10) Pub. No.: US 2012/0169611 A1
(43) Pub. Date: Jul. 5, 2012

(54) SMART TOUCH SCREEN KEYBOARD

(76) Inventor: Hanxiang Chen, Burnaby (CA)

(21) Appl. No.: 12/981,877

(22) Filed: Dec. 30, 2010

(51) Int. Cl. G06F 3/041

(52) U.S. Cl. 345/173

(57) ABSTRACT

A touch screen keyboard is described. Consistent with some embodiments, the touch screen keyboard derives a data pair representing the position of a detected finger press on a touch screen display relative to the position of a detected palm. This relative data is then compared against a set of reference data to identify an intended key press.

### TECHNICAL FIELD

The present disclosure generally relates to user-input mechanisms for computer and other electronic devices. More specifically, the present disclosure relates to software-implemented user-input applications for use with computer and electronic devices that utilize touch screen displays.

### BACKGROUND

In general, there are two commonly used types of keyboards. The first, which has long been used with conventional desktop and laptop computers, is a mechanical keyboard. The second type of keyboard, referred to as a touch screen keyboard, is utilized on various electronic and computer devices that have touch screen displays, for example, such as tablet computers.

A mechanical keyboard has certain advantages over a touch screen keyboard. In particular, when typing on a mechanical keyboard, the typist can feel the individual keys. Accordingly, if a typist's finger is not making contact correctly with an individual key, the user can feel the key and then calibrate the position of his or her hand to improve the contact made with the keys. For instance, if a typist is making contact at the edge of a key, or between two keys, the typist can sense with his fingers the location of the keys, and then make the necessary adjustments to more accurately contact the center of the individual keys. With a little practice, this calibration process becomes an almost involuntary and instinctive process, and can be done without the typist having to look down at the keyboard.

A conventional touch screen keyboard is generally not as easy to operate as a mechanical keyboard. When a typist is using a conventional touch screen keyboard the typist cannot feel with his or her fingers the boundaries of the individual keys of the keyboard. Consequently, as a typist types, he or she does not know whether his or her fingers are accurately making contact with the intended keys. It is quite easy for a typist to make typing mistakes if he or she does not occasionally look down at the visual representation of the keyboard displayed on the touch screen display, and calibrate the position of his or her hands. As a result, usually the speed of typing on traditional touch screen keyboard is much lower than on a conventional mechanical keyboard, even for the most experienced typists.

### SUMMARY

The present disclosure relates to software-implemented user-input applications for use with computer and electronic devices that utilize touch screen displays. Consistent with some embodiments, the present disclosure describes a computer-implemented method comprising, deriving a data pair representing a contact position of a finger relative to a contact position of a palm in response to detecting contact with a touch screen display, and then comparing the derived data pair to a set of reference data to identify an intended key press of a touch screen keyboard. In addition, with some embodiments, the method involves having a touch screen display present a visual representation of the touch screen keyboard. However, in other embodiments, the method is accomplished without having the touch screen display present a visual representation of the touch screen keyboard. With some embodiments, the method involves identifying a data pair in the set of reference data that most closely corresponds with the derived data pair, wherein a key associated with the data pair that most closely corresponds with the derived data pair is selected as the intended key press. With some embodiments, the data pair in the set of reference data that most closely corresponds with the derived data pair is the data pair that is closest in distance to the derived data pair. With some embodiments, the set of reference data used to identify a key press is, or has been, derived through a keyboard configuration process by which at least one reference data pair is generated for each key of a touch screen keyboard, and each data pair indicates the position of a key relative to a position of a palm. With some embodiments, a subset of the reference data pairs in the reference data are generated by detecting the positions of the fingers of a user after the user has been prompted to place his fingers on a predetermined set of reference keys displayed on the touch screen display. With some embodiments, the set of reference data are, or have been, selected to correspond with a particular brand, model, or type of mechanical keyboard. With some embodiments, when comparing the derived data pair to the set of reference data to identify an intended key press, the method includes identifying in which one of two or more regions the finger press was detected, and selecting a set of reference data to correspond with the region in which the finger press was detected. With some embodiments, a first set of reference data is associated with numeric keys corresponding with a first region and a second set of reference data is associated with alphabetic keys corresponding with a second region. With some embodiments, comparing the derived data pair to the set of reference data to identify an intended key press includes determining that the touch screen keyboard has been configured for operation in a numeric pad mode, and responsive to the determination, selecting a set of reference data associated with keys for a numeric key pad.

In addition to computer-implemented methods, some embodiments of the inventive subject matter described herein involve systems. For example, consistent with at least some embodiments, a non-transitory computer readable medium stores instructions, which, when executed by a processor, cause the processor to perform operations including, deriving a data pair representing a position where a finger press has been detected relative to a position where a palm has been detected on the touch screen display in response to detecting contact with a touch screen display, and then comparing the derived data pair to a set of reference data to identify an intended key press of a touch screen keyboard. Additionally, some embodiments involve additional instructions for causing the touch screen display to present a visual representation of the touch screen keyboard on the touch screen display. With some embodiments, additional instructions cause the processor to identify a data pair in the set of reference data that most closely corresponds with the derived data pair, wherein a key associated with the data pair that most closely corresponds with the derived data pair is selected as the intended key press. With some embodiments, the data pair in the set of reference data that most closely corresponds with the derived data pair is the data pair that is closest in distance to the derived data pair. With some embodiments, the set of reference data used to identify a key press is, or has been, derived through a keyboard configuration process by which at least one data pair is generated for each key of a touch screen keyboard, such that each data pair indicates the position of a key relative to a position of a palm. With some embodiments, additional instructions cause the processor to generate a subset of the reference data pairs in the set of reference data by detecting the positions of the fingers of a user after the user has been prompted to place his fingers on a predetermined set of reference keys displayed on the touch screen display. With some embodiments, the set of reference data are, or have been, selected to correspond with a particular brand, model, or type of mechanical keyboard. With some embodiments, additional instructions cause the processor to identify in which one of two or more regions the finger press was detected, and select a set of reference data to correspond with the region in which the finger press was detected. With some embodiments, a first set of reference data associated with numeric keys corresponds with a first region and a second set of reference data associated with alphabetic keys corresponds with a second region. With some embodiments, additional instructions cause the processor to determine that the touch screen keyboard has been configured for operation in a numeric key pad mode, and responsive to the determination, select a set of reference data associated with keys for a numeric key pad.

In addition to the methods and systems described herein, some embodiments of the inventive subject matter involve a table computer or computing device that comprises a touch screen display, a processor and memory, wherein the processor is to execute instructions stored in the memory, causing the tablet computer to derive a data pair representing a position where a finger press has been detected relative to a position where a palm has been detected on the touch screen display, and then compare the derived data pair to a set of reference data to identify an intended key press of a touch screen keyboard.

### DESCRIPTION OF THE DRAWINGS

Some embodiments are illustrated by way of example and not limitation in the figures of the accompanying drawings, in which:

FIG. 1 is a diagram illustrating an example of a conventional touch screen keyboard on a tablet computer;

FIG. 2 is a diagram illustrating how a touch screen device may identify and measure the relative position of a finger in relation to a typist's palm, consistent with some embodiments of the invention;

FIG. 3 is a diagram illustrating an example of a touch screen keyboard that detects the positions of a typist's palms and fingers, consistent with some embodiments of the invention;

FIG. 4 is a diagram illustrating an example of a touch screen keyboard operating in a numeric key pad mode, consistent with some embodiments of the invention;

FIG. 5 is a diagram illustrating an example of a touch screen keyboard having a top row of number keys, consistent with some embodiments of the invention;

FIG. 6 is a diagram illustrating an example of a touch screen keyboard operating in a training or keyboard configuration mode during which an initial, customized set of reference data are established, consistent with some embodiments of the invention;

FIG. 7 is a flow diagram representing the method operations involved in a method of processing user-inputs via a touch screen keyboard application consistent with some embodiments of the present invention; and

FIG. 8 is a block diagram of a machine in the form of a computing device within which a set of instructions, for causing the machine to perform any one or more of the methodologies discussed herein, may be executed.

### DETAILED DESCRIPTION

The present disclosure describes a software-based touch screen keyboard for use with an electronic or computer device that utilizes a touch screen device or display. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Consistent with some embodiments of the present invention, a touch screen keyboard application receives data from a touch screen display, such that the data indicates the absolute positions of a user's palm and finger, as detected by the touch screen display while the user rests his palm on the touch screen display and uses a finger to make contact with the display, such contact being referred to herein as a “finger press.” The keyboard application uses the data representing the absolute positions, which may be two data pairs or coordinate pairs, to derive a data pair that represents the position of the detected finger press relative to the position at which the palm has been detected resting on the touch screen display. For example, the derived data pair may indicate that the finger press was detected a certain number of measurement units in one direction along an X axis, and a certain number of measurement units in another direction along a Y axis, where the origin (0, 0) of the coordinate plane represents the position where the user's resting palm has been detected. Once the data pair is generated or derived, the derived data is compared to a set of reference data to determine which key was intended to be pressed by the user. For instance, the reference data may include a set of data pairs, such that each key is associated with at least one data pair. The key corresponding with the data pair from the reference data set that most closely corresponds with the derived data pair is selected as the intended key press. Other aspects of the inventive subject matter will be readily apparent based on the description of the figures that follows.

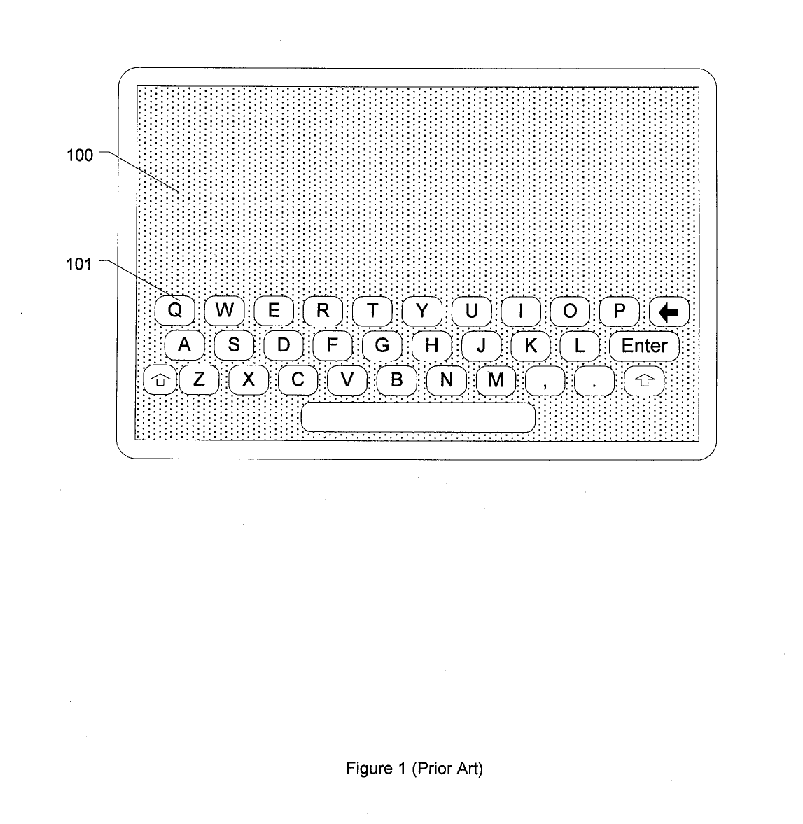

FIG. 1 is a diagram illustrating an example of a conventional touch screen keyboard on a tablet computer. As shown in the example of FIG. 1, the soft keys 101 are displayed on the touch screen 100. A conventional touch screen keyboard is not as convenient to type on as a mechanical keyboard. When a typist is typing on a conventional touch screen keyboard, the typist cannot feel the boundaries (e.g., the edges) of the individual keys. Consequently, the typist does not know whether his fingers are accurately making contact with the correct keys, in the correct (e.g., middle) position of the keys. Without watching the screen and calibrating the position of his hands every now and then, it is easy for a typist to make typing mistakes when typing on a conventional touch screen keyboard. As a result, even for the most experienced typists, typing speeds on traditional touch screen keyboards tend to be much lower than on mechanical keyboards.

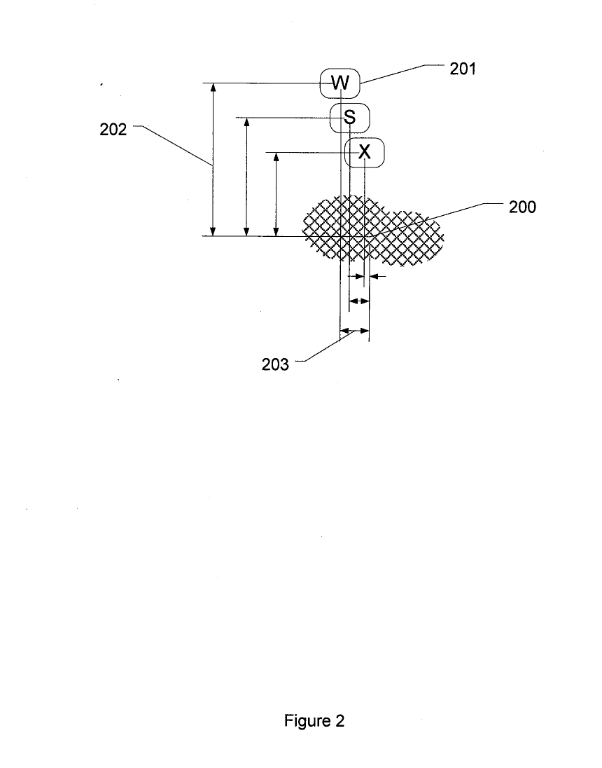

FIG. 2 is a diagram illustrating how a touch screen device may identify and measure the relative contact position of a finger press in relation to a contact position of a typist's palm resting on a touch screen display, consistent with some embodiments of the invention. Most people follow common non typing rules and behaviors when typing. Specifically, most typists use a specific finger to press or make contact with each specific key 201—an action referred to herein simply as a “finger press.” For example, typically a typist will always use the ring finger on the left hand to type the letters, W, S, and X. As shown in the example of FIG. 2, when the typist's finger makes contact with the position nearest the palm, the typist types the letter, X. Similarly, when the typist's finger makes contact with the position farthest from the palm, the typist types the letter, W. Finally, when a typist's finger makes contact with the position, which has medium distance from the palm, the typist types the letter, S. When a typist rests his palms on the touch screen device while typing, the touch screen device of the computer (e.g., tablet computer) or electronic device can detect the position of the typist's palms as resting on the touch screen display. Consistent with some embodiments, the absolute position of a typist's palm is calculated or determined by establishing the center position of the portion of the typist's palm that is resting on, and therefore detected by, the touch screen device. In the example of FIG. 2, this absolute position is indicated with reference number 200. When the touch screen device detects a finger making contact with the touch screen device in a general area of a key (e.g., a “finger press”), the absolute position of the detected finger press is determined. The absolute position of the detected finger press is then used to calculate or derive the relative position of the finger press in relation to the detected position of the user's palm resting on the touch screen device. In the example of FIG. 2, assuming a typist intended to press the letter, W, the relative position of the finger press in relation to the resting palm is shown by the lines representing the value on the X axis 203 and the value on Y axis 202. As such, the position of the finger press, relative to the absolute position of the user's resting palm could be expressed as a simple coordinate pair, (X, Y). When a typist is typing each specific key, the relative position for each specific key is generally within a small range. For different keys, the relative positions are different for many people who follow the common typing rules. Accordingly, when using the relative position as a reference, the computer can figure out which key the user actually intends to type when he or she is making contact with the touch screen with a finger press.

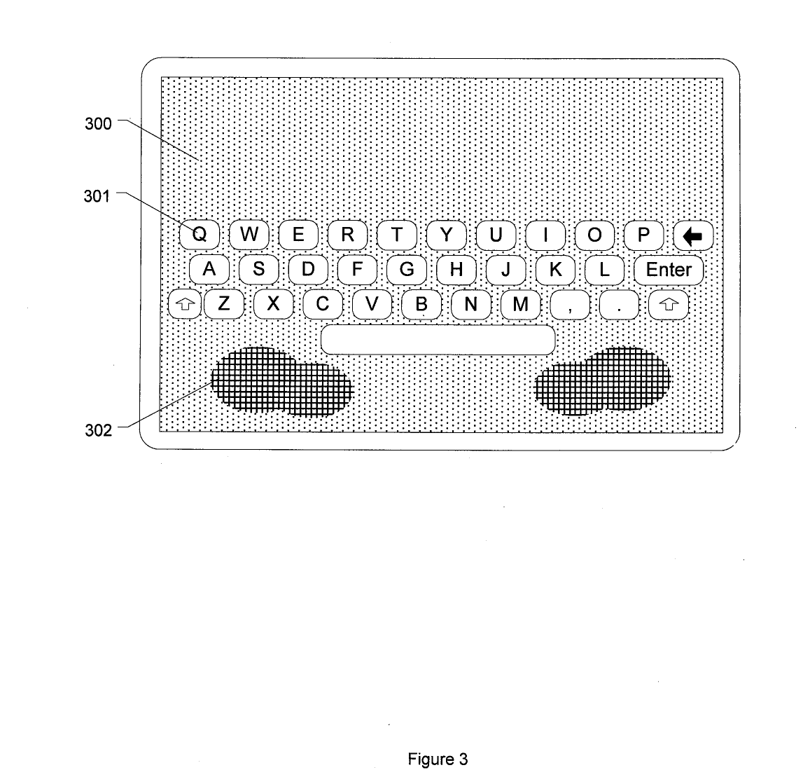

FIG. 3 is a diagram illustrating an example of a touch screen keyboard that determines an intended key press by detecting the positions of a typist's resting palms relative to his or her finger presses, consistent with some embodiments of the invention. As illustrated in FIG. 3, on the touch screen 300, there is an area displaying the keys 301 of the touch screen keyboard, where finger presses will be detected, and a separate area for detecting the position of a typist's resting palms 302. When a typist places or rests his or her palms on the touch screen 300, the absolute positions of the palms are detected or determined by the computer. The positions of keys 301 are then displayed based on the detected positions of the typist's resting palms. When a typist moves his or her palms, the keys move accordingly. With some embodiments, a user may change a setting for the touch screen keyboard to control whether or not the keys are actually displayed on the screen. For instance, because users will generally not have to look at or watch the keys while typing, with some embodiments the keyboard supports an operational mode where the individual keys are not displayed on the touch screen display.

With some embodiments, the reference data representing the relative positions of keys in relation to a detected position of a typist's palms is stored by the touch screen keyboard software application. This reference data is utilized to determine or otherwise identify the intended key presses for each detected finger press made while a user is typing. With some embodiments, a set of default reference data may be provided, such that the default reference data represents the average or likely relative positions of keys in relation to a user's resting palms for most users. In some instances, reference data may be provided to correspond with several mechanical keyboards. For instance, if a user's primary mechanical keyboard is a particular brand or model, the touch screen keyboard may provide a set of reference data to correspond with the exact key locations of the particular brand or model of mechanical keyboard. In some embodiments, a user can train or customize the touch screen keyboard according to his or her own hands with custom reference data that will, in some cases, increase the ability of the touch screen keyboard to determine the intended key presses for a user.

When a user is typing by making contact with the screen with his or her fingers (e.g., finger presses), the computer detects the absolute position of each detected finger press, and also detects the absolute position of the typist's corresponding palm resting on the touch screen device. After calculating or determining the absolute contact positions of the resting palm and finger press, the computer uses this information to calculate or determine the relative position of the detected finger press in relation to the contact position of the typist's resting palm. This relative position data is then compared with the reference data to determine which key has the closest position to the position where the finger press was detected. In other words, the key having reference data with the smallest distance to the derived relative data is selected as the intended key press.

In contrast with a conventional touch screen keyboard, where the position of keys are at fixed positions and users have to watch the keyboard and make sure their hands are at the correct positions every now and then, a smart touch screen keyboard consistent with embodiments of the invention detects an intended key press by analyzing the position of the detected contact in relation to the position of a user's resting palm. Consequently, a typist does not have to watch the screen and calibrate the positions of his or her hands while typing. Instead, the touch screen keyboard application tracks the positions of the user's palms, and calibrates the positions of the keys to ensure that the keys are always at the correct positions in relation to the user's palms.

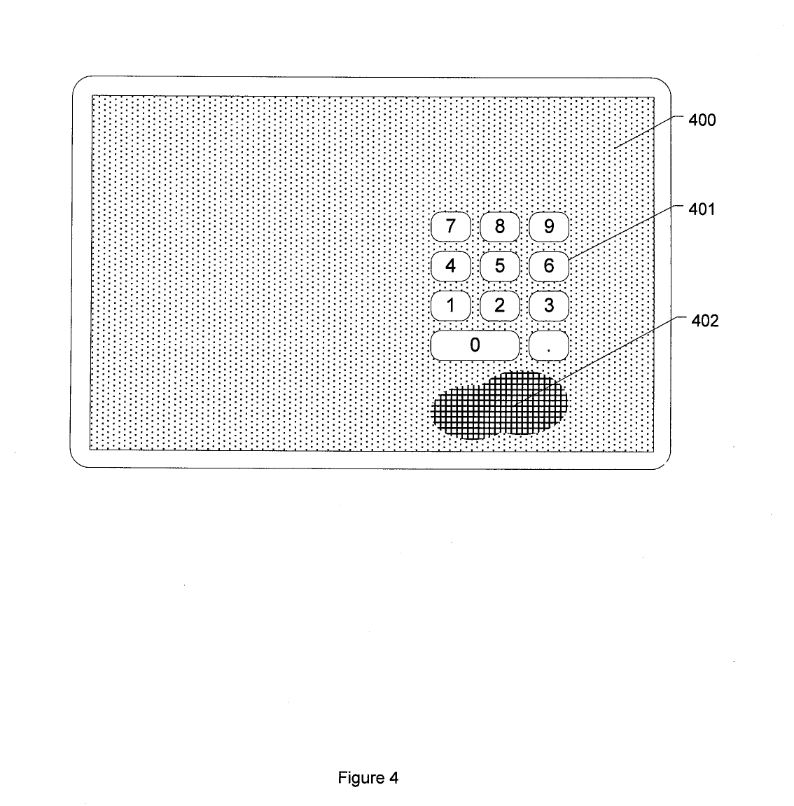

FIG. 4 is a diagram illustrating an example of a touch screen keyboard operating in a numeric key pad mode, consistent with some embodiments of the invention. Consistent with some embodiments, a smart touch screen keyboard application may have a separate operational mode for detecting user-input to a numeric key pad. For example, similar to the typing rules and behaviors exhibited by most users when using conventional mechanical keyboards, when users are typing numbers on a numeric key pad, they tend to use a specific finger for each specific number key. After selecting the keyboard application's numeric key pad mode, only numeric keys 401 are displayed on the touch screen display 400. When operating in numeric key pad mode, the numeric key pad works in the same fundamental manner as described above in connection with the touch screen keyboard. For instance, as a user moves his or palms 402, and the numeric keys move accordingly, allowing the typist to enter numbers without looking at the numeric key pad.

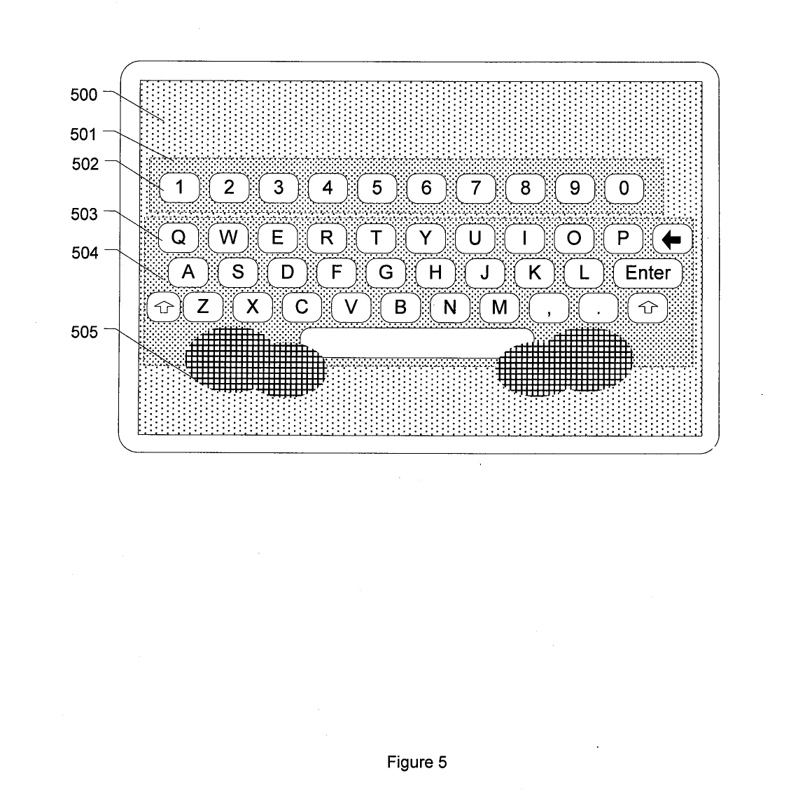

FIG. 5 is a diagram illustrating an example of a touch screen keyboard having four rows of keys for alphanumeric characters, including three rows of alphabetic keys 503 and a fourth, top row of numeric keys 502, consistent with some embodiments of the invention. In the example presented in FIG. 5, the touch screen device 500 is displaying a keyboard having three rows of alphabetic keys 503 in a first (lower) region of the touch screen 504, and a fourth (top) row with numeric keys 502 in a second (upper) region of the touch screen 501. Because the alphabetic keys 503 in the third row of the keyboard are very close to the row of numeric keys 502, and people tend to move or reposition their palms 505 higher on the keyboard when typing numeric keys, there may not be a significant enough difference in the relative position data for a finger press to accurately distinguish whether a top row number or third row letter was intended when a particular finger press is detected. For instance, the relative positions of a detected finger press and the palm for each close pair of keys may be very similar. For example, the keys “W” and “2” are close to one another, and because a user may shift his palm (up) higher on the keyboard when pressing the numeric key, “2”, the relative positions of the palm and the finger press for the keys “W” and “2” may be so similar that it is impractical to distinguish the intended key press. Accordingly, with some embodiments, to solve the problem created by the top row of numeric keys, two regions are defined for the two categories of keys—the upper region 501 is for the numeric keys, and the lower region 504 is for the alphabetic keys. When a finger press is detected in the lower region 504, the relative positions of the palm and finger press are determined and compared with the reference data to determine a letter 503 that was intended to be pressed by the user. Similarly, if the finger press is detected in the upper region 501 where the numeric keys are located, the finger press is recognized as an intended numeric key using a different set of reference data for numeric keys.

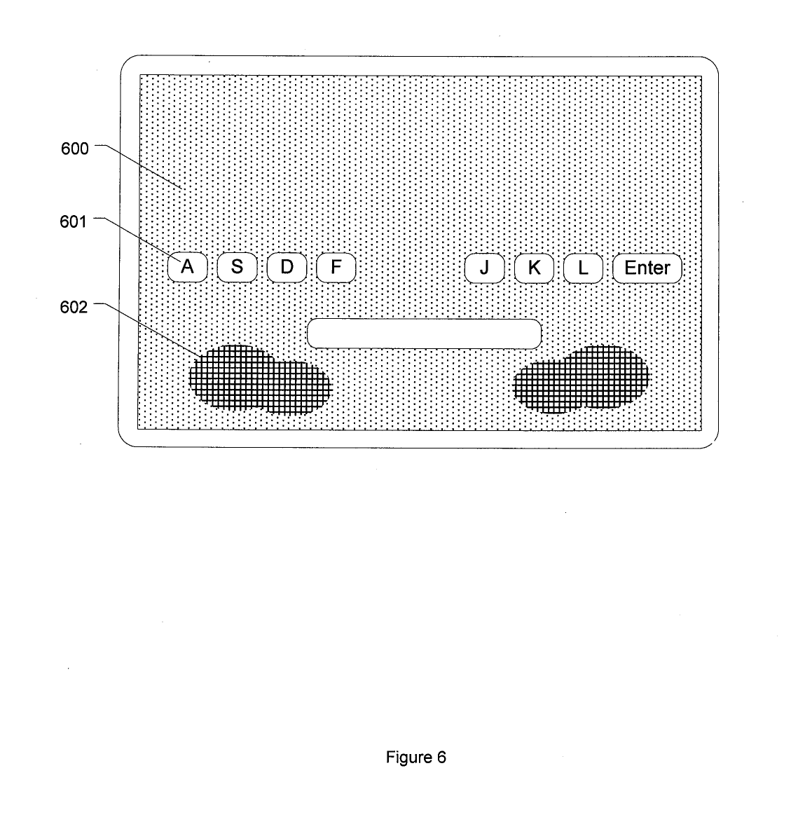

With some embodiments, the keyboard includes a set of default reference data stored with the keyboard application, and users may immediately begin directly typing without any customization or training of the keyboard. Additionally, the keyboard application may allow a user to select a set of reference data that corresponds with any number of well-known brands and models of keyboards. For instance, if a user utilizes a particular brand, model or type of mechanical keyboard, the user may be able to select a set of reference data that corresponds with his or her favorite mechanical keyboard. However, because different people have different size hands, the default reference data set may not be suitable for all users. FIG. 6 is a diagram illustrating an example of a touch screen keyboard operating in a training mode, or keyboard configuration mode, during which an initial, customized set of reference data are established, consistent with some embodiments of the invention. In the keyboard configuration mode, the user is prompted to place or position both palms 602 on the touch screen 600, and position all fingers together on the screen where he or she intends to type a particular set of reference keys 601, such as the letters, A, S, D, F, J, K, L, and the keys for (Enter) and (Space). The keyboard application operating in configuration or training mode will then detect the finger press positions, calculate the positions for all keys based on the detected finger press positions, and store the resulting reference data for subsequent use in determining individual key presses.

With some embodiments, during normal run-time operation, the keyboard application can dynamically revise the reference data associated with the various keys based on the detected position data for various finger presses. For example, assuming the relative position of a key is represented by the X and Y coordinate pair (25, 30), and at run time the user repetitively presses positions corresponding with X and Y coordinates, (25,32), (25,33), and (25,31), then the reference data for the specific key might be modified to (25,32) accordingly.

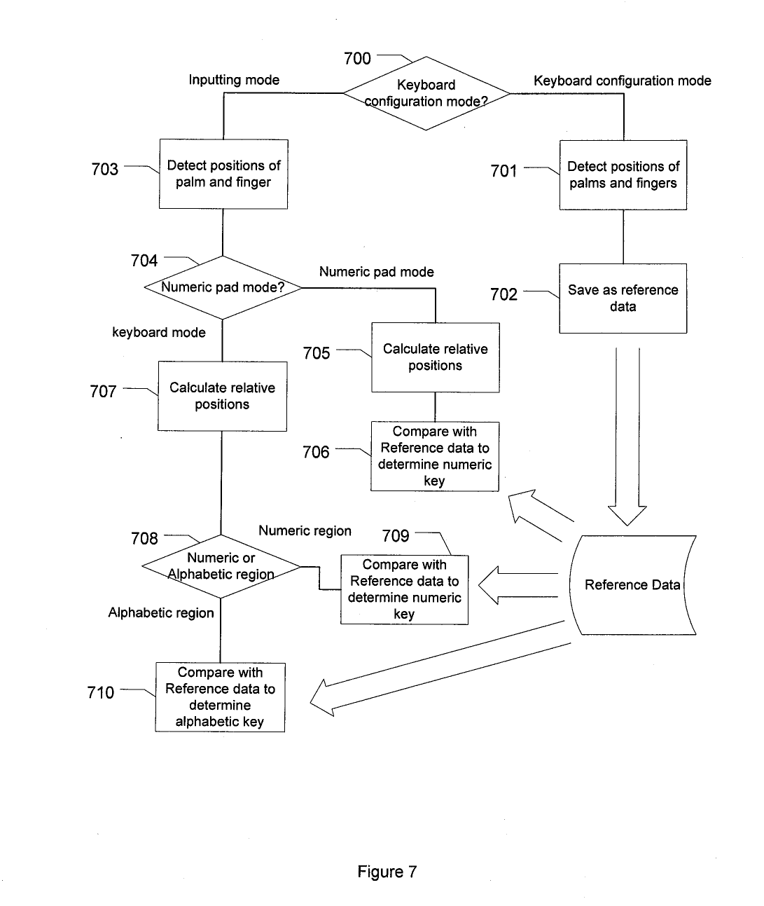

FIG. 7 is a flow diagram representing the method operations involved in a method of processing user-inputs via a touch screen keyboard application consistent with some embodiments of the present invention. For example, at method operation 700, the operational mode is determined. If the keyboard is operating in configuration or training mode, then at operation 701, the keyboard application detects the positions of the typist's resting palms and fingers on a pre-established set of reference keys, for example, such as those keys representing the starting keys in the middle row, including A, S, D, F, J, K, L, and the keys for (Enter) and (Space). The relative data for each detected finger press—that is, the contact position of each detected finger press relative to the absolute contact position of the typist's corresponding palm—is then determined. Using this data, at method operation 702, a complete set of reference data for all of the keys is derived and stored as reference data for use in determining which key was intended to be pressed during the input operational mode.

If at method operation 700, the keyboard is not in configuration mode, but is instead in input mode, then at method operation 703, the absolute positions of a resting palm and finger press are determined. Next, at method operation 704, it is determined whether the keyboard is in numeric pad mode. If in numeric pad mode, at method operation 705, the relative position of the detected finger press is determined, for example, by calculating or deriving the contact position data associated with the detected finger press relative to the contact position of the detected palm resting on the touch screen display. At method operation 706, the relative position data generated in response to a detected finger press is compared with the reference data to determine the intended numeric key press.

If the keyboard is operating in keyboard mode, then at method operation 707 the relative position data for a finger press is derived. Then, at method operation 708, the keyboard application determines the particular region (e.g., numeric region (for a top row of number keys) or alphabetic region) where the finger press was detected. If the finger press was detected in the top numeric region, then at method operation 709, the set of reference data for the numeric keys is used to determine the intended key press. If however at method operation 708, the finger press was detected in the lower alphabetic key region, then at method operation 710, the relative position data for the detected finger press is compared with the set of reference data corresponding with the keys in the lower alphabetic region to identify the intended key press.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

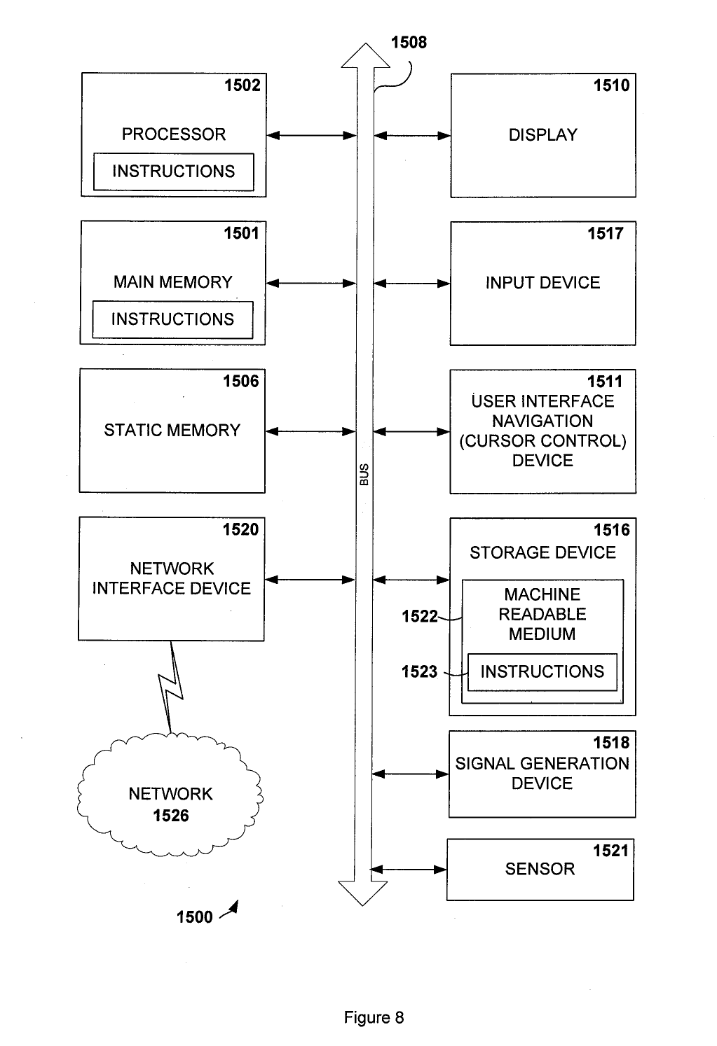

FIG. 8 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
responsive to detecting contact with a touch screen display, deriving a data pair representing a contact position where a finger press was detected on the touch screen display relative to a contact position where a resting palm was detected on the touch screen display; and
comparing the derived data pair to a set of reference data to identify an intended key press of a touch screen keyboard.

2. The computer-implemented method of claim 1, wherein the touch screen display presents a visual representation of the touch screen keyboard.

3. The computer-implemented method of claim 1, wherein the touch screen display does not present a visual representation of the touch screen keyboard.

4. The computer-implemented method of claim 1, wherein comparing the derived data pair to a set of reference data to identify an intended key press includes identifying a reference data pair in the set of reference data that most closely corresponds with the derived data pair, wherein a key associated with the reference data pair in the set of reference data that most closely corresponds with the derived data pair is selected as the intended key press.

5. The computer-implemented method of claim 2, wherein the reference data pair in the set of reference data that most closely corresponds with the derived data pair is the reference data pair that is closest in distance to the derived data pair.

6. The computer-implemented method of claim 1, wherein the set of reference data used to identify the intended key press has been derived through a keyboard configuration process by which at least one reference data pair is generated for each key of a touch screen keyboard, each reference data pair in the set of reference data representing a relative position of a key in relation to a position of a palm.

7. The computer-implemented method of claim 6, wherein a subset of the reference data pairs in the set of reference data are generated by detecting the contact positions of the fingers of a user after the user has been prompted to place his fingers on a predetermined set of reference keys displayed on the touch screen display.

8. The computer-implemented method of claim 1, wherein the set of reference data have been selected to correspond with a particular brand, model, or type of mechanical keyboard.

9. The computer-implemented method of claim 1, wherein comparing the derived data pair to the set of reference data to identify an intended key press includes identifying in which one of two or more regions the finger press was detected, and selecting a set of reference data to correspond with the region in which the finger press was detected.

10. The computer-implemented method of claim 9, wherein a first set of reference data associated with numeric keys corresponds with a first region and a second set of reference data associated with alphabetic keys corresponds with a second region.

11. The computer-implemented method of claim 1, wherein comparing the derived data pair to the set of reference data to identify an intended key press includes determining that the touch screen keyboard has been configured for operation in a numeric pad mode, and responsive to the determination, selecting a set of reference data associated with keys for a numeric key pad.

12. A non-transitory computer readable medium storing instructions thereon, which, when executed by a processor, cause the processor to perform the following operations:
responsive to detecting contact with a touch screen display, derive a data pair representing a contact position where a finger press was detected on the touch screen display relative to a contact position where a resting palm was detected on the touch screen display; and
compare the derived data pair to a set of reference data to identify an intended key press of a touch screen keyboard.

13. The computer readable medium of claim 12, storing additional instructions that cause the touch screen display to present a visual representation of the touch screen keyboard.

14. The computer readable medium of claim 12, storing additional instructions that cause the processor to identify a reference data pair in the set of reference data that most closely corresponds with the derived data pair, wherein a key associated with the reference data pair in the reference data that most closely corresponds with the derived data pair is selected as the intended key press.

15. The computer readable medium of claim 12, wherein the reference data pair in the set of reference data that most closely corresponds with the derived data pair is the reference data pair that is closest in distance to the derived data pair.

16. The computer readable medium of claim 12, wherein the set of reference data used to identify the intended key press has been derived through a keyboard configuration process by which at least one reference data pair is generated for each key of a touch screen keyboard, each reference data pair in the set of reference data representing a relative position of a key in relation to a position of a palm.

17. The computer readable medium of claim 16, storing additional instructions that cause the processor to generate a subset of the reference data pairs in the set of reference data by detecting the contact positions of the fingers of a user after the user has been prompted to place his fingers on a predetermined set of reference keys displayed on the touch screen display.

18. The computer readable medium of claim 12, wherein the set of reference data have been selected to correspond with a particular brand, model, or type of mechanical keyboard.

19. The computer readable medium of claim 12, storing additional instructions that cause the processor to identify in which one of two or more regions the finger press was detected, and select a set of reference data to correspond with the region in which the finger press was detected.

20. The computer readable medium of claim 19, wherein a first set of reference data associated with numeric keys corresponds with a first region and a second set of reference data associated with alphabetic keys corresponds with a second region.

21. The computer readable medium of claim 12, storing additional instructions that cause the processor to determine that the touch screen keyboard has been configured for operation in a numeric key pad mode, and responsive to the determination, select a set of reference data associated with keys for a numeric key pad.

22. A tablet computer comprising:
a touch screen display; and
a processor communicatively coupled to a memory, the processor to execute instructions stored within the memory and to cause the tablet computer to i) derive a data pair representing a contact position where a finger press was detected on the touch screen display relative to a contact position where a resting palm was detected on the touch screen display, and ii) compare the derived data pair to a set of reference data to identify an intended key press of a touch screen keyboard.
